(19) United States
(12) Patent Application Publication
(10) Pub. No.: US 2011/0168818 A1
(43) Pub. Date: Jul. 14, 2011

(54) PLANT FOR RECYCLING TIRES

(76) Inventor: Roberto Verri, Milano (IT)

(21) Appl. No.: 13/060,108

(22) PCT Filed: Aug. 31, 2009
(86) PCT No.: PCT/IB2009/006676

§ 371 Date: Mar. 30, 2011

(30) Foreign Application Priority Data
Aug. 29, 2008 (IT) MI2008A001558

(51) Int. Cl. B02C 19/00

(52) U.S. Cl. 241/101.2

(57) ABSTRACT

The present invention concerns a plant (1) for recycling tires using Water Jet technology, comprising a first workstation (2) for selecting and loading at least one tire (8) into a second workstation (3), said second workstation (3) being adapted to disintegrate said tires (8) loaded therein; Particularly, the second workstation (3) comprises an accessory (10) for support and retention of the tires, which has retaining means (13) that define a housing for said at least one tire (8), said retaining means (13) include a plurality of sectors (14) adapted to circumscribe said at least one tire (8), and first drive means (15) operably associated with said plurality of sectors (14) to cause said plurality of sectors to be reversibly displaced towards and away from a central portion of said support (12) to move between a first operating state (C1) and a second operating state (C2), and comprises a first Water Jet device (11) adapted to disintegrate said at least one tire (8) by delivering a high pressure fluid.

### TECHNICAL FIELD

The present invention relates to a plant for recycling tires using Water Jet technology, comprising a first workstation for selecting and loading at least one tire into a second workstation, said second workstation being adapted to disintegrate said tires loaded therein.

### BACKGROUND OF THE INVENTION

Modern society mainly bases its economy and development on road transport. Thus, delivery of goods and services, implementation of industrial processes, as well as private or play activities rely on the use of cars, trucks, motorcycles, tractors, etc., which employ tires every day.

Tires are known to have a limited life and have to be replaced when they become useless. Unusable tires, such as excessively worn or damaged tires, are known as scrap tires.

As used herein, the term damaged tire is intended to indicate a punctured, cut, burst tire, or a tire having a loose tread (i.e. separated from the shoulders).

Scrap tires are a contaminating product, one tire, e.g. a car tire, taking 100 years to full disposal.

Considering that the scrap tires waiting for disposal every year can be counted in hundreds of thousands of tons, such scrap tires apparently create a major environmental concern.

Scrap tire recycling requires the scrap tire to be split into its main components, such as the textile, metal (typically steel) and rubber components.

A variety of solutions have been proposed for this purpose, but no scrap tire recycling attempt heretofore has reached environmentally compatible and/or cost-effective results.

Some of the mechanical scrap tire recycling plants known in the art can recover a more or less substantial portion of the rubber, but only partially address the problem of recovering the other components.

In recent times, plants have been introduced for scrap tire recycling which include a water-jet device capable of generating fluid jets, such as high pressure water jets, which allow separation of rubber from the other components, but these plants do not address the problem of recovery and recycling of the textile and metal components.

Particularly, it shall be noted that Water Jet disintegration of the tire is obtained by a high pressure fluid jet delivered by a nozzle moving along a predetermined path according to a special program; the nozzle is associated, for example, with a mechanical Cartesian arm.

Fluid pressurization is obtained using pressure boosting pumps which multiply pressure above 3000 bar.

In view of the above prior art, the object of the present invention is to provide a scrap tire recycling plant that has such structural and functional characteristics as to fulfill the above needs, while obviating the above prior art drawbacks.

### SUMMARY OF THE INVENTION

This problem is solved by a plant for recycling tires using Water Jet technology, comprising a first workstation for selecting and loading at least one tire into a second workstation, said second workstation being adapted to disintegrate said tires loaded therein;

wherein said second workstation comprises:
an accessory having a support extending in a first preset direction for supporting at least one tire and retaining means extending in a second preset direction transverse to said first preset direction, said retaining means cooperating with said support to define a housing for said at least one tire, said retaining means comprise a plurality of sectors extending parallel to said second direction, said plurality of sectors being adapted to circumscribe said at least one tire and first drive means operably associated with said plurality of sectors to cause said plurality of sectors to be reversibly displaced towards/away from a central portion of said support to move between a first operating state (C1) and a second operating state (C2) and
a first Water Jet device being adapted to disintegrate said at least one tire by delivering a high pressure fluid. The present invention provides a scrap tire recycling plant that allows simultaneous disintegration of multiple tires, thereby ensuring a considerably enhanced throughput, and hence considerable advantages in terms of cost effectiveness.

Finally, the present invention provides a scrap tire recycling plant that can obtain the following residual materials from tire disgregation:
rubber crumb or granules, that can be sold in several different cuts,
steel and
nylon fibers.

Advantageously, the above plant can allow rubber granules, crumb or dust to be formed without touching the steel that forms the metal structure of the tire, thereby ensuring improved material recovery as compared with currently operating plants.

### BRIEF DESCRIPTION OF THE DRAWINGS

The characteristics and advantages of the invention will appear from the following detailed description of one practical embodiment, which is illustrated without limitation in the annexed drawings, in which:

FIG. 1 shows a basic scheme of the plant for recycling tires, particularly scrap tires using Water Jet technology, according to the present invention;

FIG. 2 is a cross sectional view of a workstation of the plant of FIG. 1 during a tire disintegration step, according to the present invention.

FIG. 3 is another cross sectional view of the workstation of FIG. 2 during another tire disintegration step, according to the present invention.

FIG. 4 is another cross sectional view of the workstation of FIG. 2 during a step of collection of residual materials resulting from the disintegration steps as shown in FIGS. 2 and 3, according to the present invention.

### DETAILED DESCRIPTION OF THE PREFERRED EMBODIMENTS

While reference will be made hereinafter to scrap tires, the accessory, workstation and plant as disclosed herein are obviously indented to be capable of processing perfectly usable tires and not necessarily scrap tires, by Water Jet technology.

Bearing this in mind, and referring to the accompanying figures, numeral 1 generally designates a plant for recycling scrap tires using Water Jet technology.

The plant 1 comprises a plurality of workstations 2, 3, 4, 5, 6 and 7, which are designed to be controlled and operated by appropriate programmable control and operation means (not shown).

For instance, the programmable control and operation means consist of a PLC.

Therefore, the PLC can supervise and coordinate the operations to be accomplished by each workstation 2, 3, 4, 5, 6 and 7, as well as their interoperability to ensure proper operation of the recycling plant 1.

The first station 2 of the plant 1 may be an “intelligent” station in which one or more scrap tires 8 are selected and loaded into the second station 3.

Particularly, the first station 2 can select the scrap tires 8 by appropriate selection means, according to tread size, weight and thickness.

Once the scrap tires 8 have been sorted, scrap tires 8 with substantially the same diameters, weights and thicknesses are introduced into appropriate loaders 9.

These loaders transfer homogeneous scrap tires 8 to the second workstation 3.

It shall be noted that, once homogeneous scrap tires have been introduced into the loaders 9, the data collected during selection are transmitted to the second workstation 3 for best performance of the disintegration of scrap tires.

Such second workstation 3 is a station in which the scrap tires 8 are disintegrated and comprises:
an accessory 10 and
a Water Jet device 11 for disintegrating the rubber and fabric that form the scrap tire 8.

Particularly, the accessory 10 comprises a support 12 extending in a first preset direction X-X for supporting at least one tire 8 and possibly retaining means 13 extending in a second preset direction Y-Y transverse to said first preset direction X-X.

Particularly, the retaining means 13 cooperate with the support 12 to define a housing for at least one scrap tire 8.

It shall be noted that the retaining means 13 include a plurality of sectors 14, extending parallel to the second direction Y-Y, which are conformed to circumscribe the scrap tires 8 lying on the support 12.

Furthermore, it shall be noted that the accessory 10 comprises drive means 15 that are operably associated with the plurality of sectors 14 to cause the plurality of sectors 14 to be reversibly displaced towards/away from a central portion of the support 12 to move between a first operating state C1 and a second operating state C2.

This leads to a corresponding expansion/contraction of the plurality of sectors 14 of the retaining means 13, allowing to retain scrap tires of different diameters.

In other words, when one or more scrap tires 8 lie on the support 12, the plurality of sectors 14 are controlled by the control and operation means, to assume a state intermediate between the first operating state C1 and the second operating state C2, such state being dependent on the radial size of said scrap tires 8 lying on the support itself.

Advantageously, the above feature allows retention of tires having different radial sizes, e.g. falling in a range from 600 to 1500 mm, without requiring any intervention for replacement of the retaining means 13 and affording a higher throughput of the plant 1 per time unit.

For each sector of said plurality of sectors 14 the drive means 15 have at least one actuator 20 mechanically connected to its respective sector 14 so that any movement of the actuator leads to a displacement between the first operating state C1 and the second operating state C2 of the plurality of sectors 14.

Furthermore, each actuator of the drive means 15 is mechanically connected via suitable mechanisms to a sector 14 and to the support 12.

According to a preferred aspect, the plurality of sectors 14 extend perpendicular to the first preset direction X-X, to create a retaining barrier or fence.

Preferably, the retaining barrier is as high as to be able to retain up to six concentric tires in the direction of extension.

It shall be noted that the sectors 14 of the accessory 10 are made of perforated sheet metal; its holes have such a size as to allow the passage of the residues (i.e. rubber crumbs, textile particles and fluid) obtained from disintegration of the tire 8.

Particularly, a size of such holes may fall in a range from 3 to 10 mm.

According to a preferred aspect of the present invention, the support 12 is provided as a support plate formed of one-piece grid of appropriate size (e.g. with a 100×50 mm mesh size) to allow the passage of residues (i.e. rubber crumbs, textile particles and fluid) obtained from disintegration of the tire 8.

It shall be noted that the accessory 10 further comprises a plurality of centering elements 16, extending parallel to each other in the second direction Y-Y to hold the scrap tires 8 in a preset position.

Particularly, these centering elements 16 are reversibly displaceable to and from the center of the support 12 thanks to appropriate drive means 17, to move between a third operating state C3 and a fourth operating state C4.

The centering elements 16 ensure that a predetermined distance always exists between one sector 14 and the tread of the tire 8, regardless of the type of tire 8 lying on the support 12.

In other words, the centering elements 16 are controlled by the control and operation means to take a preset position, according to the diameter of the scrap tires 8 to be processed.

For each centering element 16 the drive means 17 have at least one actuator mechanically connected to its respective centering element 16 so that any movement of the actuator 20 leads to a displacement between the third operating state C3 and the fourth operating state C4.

Furthermore, each actuator is mechanically connected via suitable mechanisms to a centering element 16 and to the support 12 respectively.

In a preferred embodiment, the centering elements 16 are in the form of rods having a cylindrical and/or parallelepipedal plan shape, oriented perpendicular to the support 10.

The accessory 5 further comprises motor means 18 operably connected with the support 12 for rotating the support.

It will be appreciated that the motor means 18 are protected by a casing 19 to ensure imperviousness to the fluid delivered by the Water Jet device 11 during disintegration of the scrap tires 8.

Thus, upon operation of the motor means 18, the support 12 and the scrap tires 8 thereon are rotated.

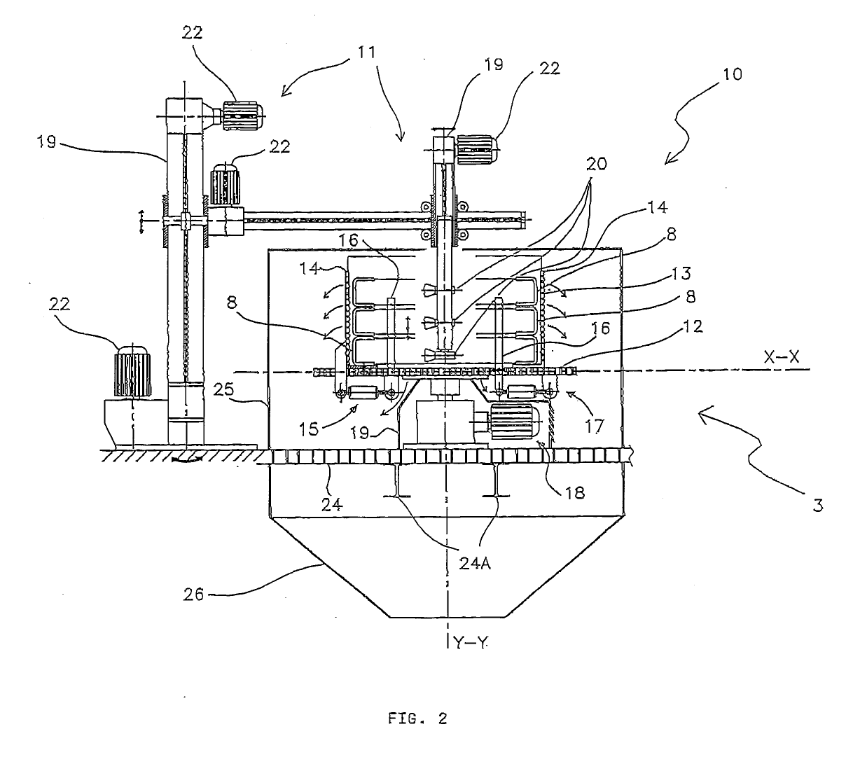

The second workstation 3, also with reference to FIG. 2, comprises a Water-Jet device 11, which in turn has:
swinging means 19, with at least one nozzle (or delivery head) associated therewith.

Such at least one nozzle 20 is capable of directing a high pressure flow of fluid, such as water, against at least one portion of the scrap tire 8.

Still referring to FIG. 2, according to one aspect of the present invention, the delivered fluid flow is shown to have a propagation component substantially parallel to the direction of extension X-X of the support 12.

In other words, the nozzle 20 is oriented perpendicular to the tread and side surfaces of the scrap tire 8.

Preferably, the nozzles 20 associated with the swinging means 19 are as many as the scrap tires 8 lying on the support 12.

For example, three nozzles 20 are provided in the arrangement of FIG. 2, because three scrap tires lie on the support 12 for simultaneous disintegration.

Particularly, in a preferred embodiment, the swinging means 19 include a pair of mechanical Cartesian arms, one extending in the direction Y-Y (i.e. vertically) and the other extending in the direction X-X (i.e. horizontally).

It shall be noted that the nozzle 20 is associated with the mechanical arm that extends in the direction X-X.

Also, it shall be noted that these two arms are controlled by appropriate motors 22, which are controlled by the control and operation means.

Particularly, these motors 22 allow the mechanical arms to impart translational movements in the first direction X-X and the second direction Y-Y and rotary movements about such second direction Y-Y.

Therefore, once the tires 8 (e.g. up to six tires) are laid on the support 12 of the accessory 10, the mechanical arm with the nozzles 20 moves to a predetermined operating position in which the nozzles 20 are at such a height from the support 12 and at such a distance from the walls of the sector 14 as to ensure optimal disintegration of the tires 8.

Still referring to FIG. 2, it will be appreciated that the second workstation 3 also comprises a cover 25 associated with a hopper 26 capable of containing and collecting the disintegration residues as well as the fluids delivered by the Water Jet device 11.

Once the tread of the scrap tires 8 lying on the support 12 has been disintegrated, the second workstation 3 is designed to accomplish disintegration of the scrap tires 8.

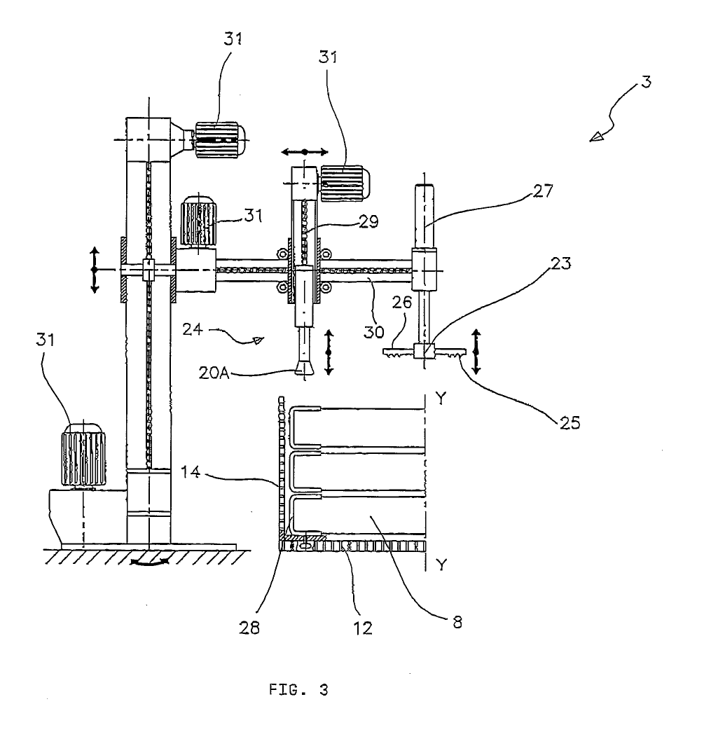

For this purpose, also referring to FIG. 3, the second workstation 3 further comprises:
presser means 23, for pressing the shoulders of the scrap tires 8 towards each other in the axial direction X-X, and
an additional Water Jet device 24.

Advantageously, the presser means 23 include a pushing member 25 movable in the first direction X-X, preferably the axial direction.

The pushing member 25 is preferably situated at the distal end of a radial arm 26; the proximal end 15 of the radial arm 26 is advantageously secured to the lower end of a first vertical arm 27.

Advantageously, the lower end is movable in the axial direction X-X, whereas the radial arm 26 may be axially fixed relative to the lower end.

Advantageously, the presser means 23 include a plurality of, preferably three or four, radial arms 26, to exert a substantially radially balanced pressure upon the shoulders of the scrap tires 8.

Advantageously, the distal end of the radial arm 26 is movable in the radial direction, i.e. a direction perpendicular to the axial direction.

The distal ends 14 may be radially moved using the control and operation means, for the pushing members 25 to be disposed axially above the shoulders 28 of the scrap tires 8.

The second workstation 2 further comprises the additional a Water Jet device 24 for disintegrating the shoulders 28 of the scrap tires 8 lying on the support 12.

The Water-Jet device 24 is equipped with one or more nozzles 20A and is conveniently associated with second swinging means 29 which, in the preferred embodiment, consist of a second vertical arm 29.

It shall be noted that the one or more nozzles 20A are placed at the lower end and move in the axial direction Y-Y.

Therefore, the lower end 19 is movable in the axial direction X-X and is integral with the Water Jet device 24.

The first and second vertical arms 26, 29 are advantageously disposed on a second radial arm 30.

Advantageously, the second radial arm 30 is movable between a first operating state, in which it allows operation of the presser means 23 and the Water Jet device 24 on the scrap tires 8 loaded on the support 12, and a second state, in which such operation is not allowed.

Advantageously, the motion between the first and second states is a rotary motion about the second direction Y-Y, parallel to the direction X-X but spaced therefrom.

Advantageously, appropriate motor means 31 are provided to allow displacement of the arms 27, 29 and the second radial arm 30.

Once one or more, for example three scrap tires 8, have been loaded onto the support 12, concentrically with the axis Y-Y, and the Water-Jet device 11 has disintegrated substantially the whole tread of the scrap tires 8, then the presser means 23 move axially downwards and press together all the shoulders of the one or more scrap tires 8.

Upon contact of the shoulders, the Water-Jet device 24 operates to disintegrate the shoulders 28 of the scrap tires 8.

Namely, during disintegration of the treads, the presser means 23 are in the second state, to avoid any interference with the above operations.

In other words, the shoulders 28 of the scrap tires 8 are pressed together substantially to contact, thereby forming a substantially solid rubber ring.

Then, the Water-Jet device 24 is disposed at a proper radial distance axially above the shoulders 28 of the scrap tires 8, and is operated to disintegrate the shoulders by fluid delivery.

Once the above operations have been completed, the presser means 23 are moved back to the second state.

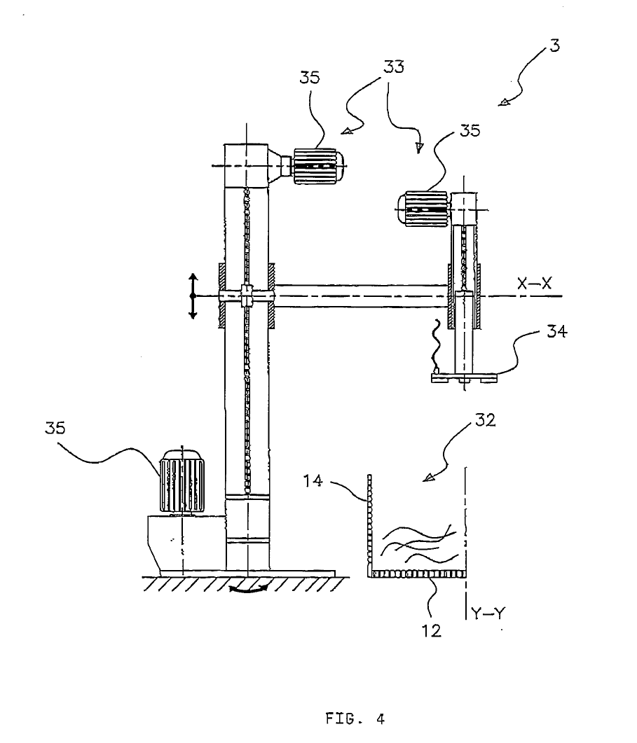

Now, the housing defined by the retaining means 13 and the support 12, also referring to FIG. 4, only contains the metal part 32 of the disintegrated scrap tires 8, as the rubber powder and the fabric obtained from the disintegration that takes place in the second station 3 may be collected, with the fluid used by the Water-Jet devices 11 and 24, in a collection tank 33 that is part of the third workstation 6.

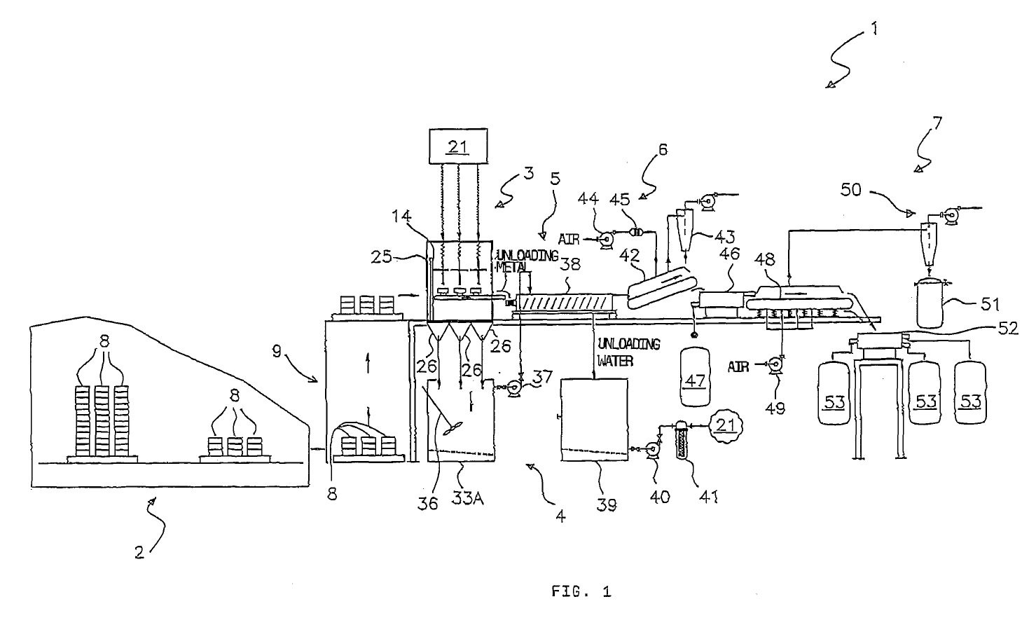

It shall be noted, also referring to FIG. 1, that a storage and feeding station for the Water-Jet devices 11 and 24, generally designated by numeral 1, is provided in the plant 1, and particularly such storage station 21 has means for ensuring delivery of fluid at the proper rate and pressure to the nozzles 20, as well as generation of the power required for the motors to increase fluid pressure to the optimal values to perform disintegration.

Still referring to FIG. 4, for recovery of the metal residue 32 (i.e. steel) of the disintegrated scrap tires 8, the second workstation 3 further has swinging means 33 with at least one magnetic clamping table 34 associated therewith for magnetically clamping said metal residues 32.

Particularly, in a preferred embodiment, the swinging means 33 include a pair of mechanical Cartesian arms, one extending in the direction Y-Y (i.e. vertically) and the other extending in the direction X-X (i.e. horizontally).

It shall be noted that the magnetic table 34 is associated with the mechanical arm that extends in the direction. X-X.

Also, it shall be noted that these two arms are controlled by appropriate motors 35, which are controlled by the control and operation means.

Particularly, these motors 35 are electric motors that allow the mechanical arms to impart translational movements in the first direction X-X and the second direction Y-Y and rotary movements about such second direction Y-Y.

Therefore, the metal residues 32 on the support 12 are recovered by having the magnetic table 34 move, under the supervision of the control and operation means, close to such metal residues 32. Once it has moved close to the metal residues 32, the magnetic circuits in the magnetic table 34 are actuated to recover such residues by magnetic attraction, and carry them into a collection point of the plant 1.

It shall be noted that, in order to reach performances that can ensure greater cost effectiveness, the second workstation 3 of the plant, for disintegrating scrap tires 8, has a plurality of, such as six accessories 10.

Referring now to FIG. 1, the powder granules and the textile particles are held in suspension within the tank 33A of the third workstation 4, in the fluid delivered by the Water-Jet device/s 11 and/or 24, using suitable stirring means 36.

The water-rubber crumbs suspension is conveyed to a centrifuge 38 that is part of the fourth workstation 5, to obtain wet crumbs with a very low moisture content.

The pump 37 is controlled according to the level of liquid in the tank 33A.

The fluid that comes out of the centrifuge 38 is collected in an additional collection tank 39, which has a minimum and maximum level control, for controlling an additional pump 40 for backflow of the fluid, once it has been filtered by appropriate filtering means 41 to the storage tank in the section 21.

A fifth workstation 6 receives rubber crumbs from the fourth workstation 5 and further dries such crumbs.

Particularly, the fifth workstation 6 consists of a conveyor belt 42 with a hood 43 thereon, the latter having electric air heating means 44 and blowers 45 for blowing said hot air onto the conveyor belt 42.

The presence of rubber crumbs on the conveyor belt 42 is detected, for instance, by suitable optical means.

Once the rubber crumbs have been dried, hot air is recovered by a fan and cyclone system.

Once the rubber crumbs have been dried on the conveyor belt 42, they are transmitted to a screening system 46 for grain size sorting, such screening system 46 being part of the sixth workstation 7 of the plant 1.

Particularly, the screening system 46 separates finer rubber crumbs from coarse ones.

Finer rubber crumbs are stored in a container 47.

Furthermore, the remaining rubber crumbs are transmitted to a vibrating table 48 which separates rubber crumbs from textile particles both by vibration and by the effect of air blow thereunder by a blower 49.

Thus, the textile part is removed by suction by a fan and cyclone system 50 and discharged into a special container 51.

The rubber crumbs are discharged from the vibrating table 48 into a screen 52 for grain size sorting thereof.

Particularly, the rubber crumbs are sorted into different containers 53 according to their grain size.

Therefore, this plant 1 provides an unprecedented material purity as well as a high yield per time unit.

In view of the above description and considering the different types of possible damages of a tire, particularly loose tread, a skilled person can easily appreciate that all the characteristics, features and advantages of the above plant may be maintained unaltered even when the plant is used for disintegration of portions of tires. These portions may be, for instance, shoulders obtained either from loose-tread tires or from specially separated scrap tires.

The same shall also apply to the teachings of Patent Applications MI2008A00A001559, PCT/IT2008/000561, PCT/IT2008/000562, MI2008A001560 and MI2008A001558.

Those skilled in the art will obviously appreciate that a number of changes and variants may be made to the arrangements as described hereinbefore to meet specific needs, without departure from the scope of the invention, as defined in the following claims.

1-13. (canceled)

14. A plant for recycling tires using Water Jet technology, comprising a first workstation for selecting and loading at least one tire into a second workstation, said second workstation being adapted to disintegrate said tires loaded therein;
wherein said second workstation comprises:
an accessory having a support extending in a first preset direction for supporting at least one tire and retaining means extending in a second preset direction transverse to said first preset direction, said retaining means cooperating with said support to define a housing for said at least one tire, said retaining means comprise a plurality of sectors extending parallel to said second direction, said plurality of sectors being adapted to circumscribe said at least one tire and first drive means operably associated with said plurality of sectors to cause said plurality of sectors to be reversibly displaced towards/away from a central portion of said support to move between a first operating state (C1) and a second operating state (C2) and
a first Water Jet device being adapted to disintegrate said at least one tire by delivering a high pressure fluid.

15. A plant for recycling tires as claimed in claim 14, wherein said accessory comprises a plurality of centering elements extending parallel to each other in said second direction to hold said at least one tire in a preset position and second drive means operably associated with said plurality of centering elements to cause said plurality of centering elements to be reversibly displaced towards/away from said central portion of said support to move between a third operating state (C3) and a fourth operating state (C4).

16. A plant for recycling tires as claimed in claim 14, wherein said Water Jet device comprises swinging means with at least one nozzle associated therewith for directing said high pressure fluid flow against at least one portion of a tire.

17. A plant for recycling tires as claimed in claim 16, wherein said swinging means include a first pair of mechanical Cartesian arms capable of translation and/or rotation in said first and said second directions.

18. A plant for recycling tires as claimed in claim 14, comprising presser means for pressing said shoulders (102) of said tire towards each other in said second direction of extension, said presser means including a pushing member movable in said second direction of extension.

19. A plant for recycling tires as claimed in claim 18, comprising a second Water Jet device which has second swinging means with at least one nozzle (20A) associated therewith for directing said high pressure fluid flow against said shoulders of said tire.

20. A plant for recycling tires as claimed in claim 19, wherein said second swinging means comprise an arm extending in said second direction and movable in said second direction with which said nozzle (20A) is associated.

21. A plant for recycling tires as claimed in claim 14, comprising third swinging means with at least one magnetic clamping table associated therewith for magnetically clamping the metal residues of said at least one tire.

22. A plant for recycling tires as claimed in claim 21, wherein said swinging means include a second pair of mechanical Cartesian arms, one extending in the second direction of extension and the other extending in the first direction of extension.

23. A plant for recycling tires as claimed in claim 14, comprising a third workstation for collecting the rubber and textile particles disintegrated in said second disintegration workstation as well as the fluid delivered by said first Water Jet device and/or said second Water Jet device, said third workstation being adapted to hold the rubber and textile particles in suspension in the fluid delivered by said first Water Jet device and/or said second Water Jet device, using suitable stirring means.

24. A plant for recycling tires as claimed in claim 23, comprising a fourth workstation for receiving the wet rubber crumbs from said third workstation and centrifuging said wet rubber crumbs to obtain rubber crumbs with a very low moisture content.

25. A plant for recycling tires as claimed in claim 24, comprising a fifth workstation for receiving the rubber crumbs from the fourth station and further drying said rubber crumbs.

26. A plant for recycling tires as claimed in claim 25, comprising a sixth workstation for receiving the rubber crumbs from the fifth station and separating said rubber crumbs according to their size.
